(19) United States
(12) Patent Application Publication
(10) Pub. No.: US 2019/0043258 A1
(43) Pub. Date: Feb. 7, 2019

(54) Dynamic Arrangement of Elements in Three-Dimensional Space

(71) Applicant: Facebook, Inc., Menlo Park, CA (US)

(72) Inventors: Zbigniew Szymanski, London (GB); Michael Slater, Nottingham (GB); Mircea-Gabriel Suciu, London (GB); Alexander Nicholas Rozanski, London (GB); Guilherme Schneider, London (GB); Milen Georgiev Dzhumerov, Sevenoaks (GB); Alexander Charles Henderson, London (GB); Volodymyr Giginiak, London (GB)

(21) Appl. No.: 15/666,205

(22) Filed: Aug. 1, 2017

(51) Int. Cl. G06T 19/00; G06T 15/20; G06F 17/22; G06F 17/21

(52) U.S. Cl. CPC G06T 19/00; G06T 15/20; G06F 3/04815; G06F 17/211; G06T 19/006; G06F 17/2247

(57) ABSTRACT

In one embodiment, a method includes determining one or more three-dimensional (3D) objects defined in 3D space for display. The one or more 3D objects may be projected into corresponding one or more two-dimensional (2D) objects defined in 2D space. Run-time layout characteristics of the one or more 2D objects may be defined using a layout module. The run-time layout characteristics defined by the layout module may be send to a 3D rendering engine. The 3D rendering engine may render a display containing the one or more 3D objects using the run-time layout characteristics of the one or more 2D objects defined by the layout module.

### TECHNICAL FIELD

This disclosure generally relates to a method for dynamically arranging three-dimensional (3D) objects in a display.

### BACKGROUND

Cascading style sheets (CSS) is a style sheet language used for describing the presentation of a document written in a markup language, such as Hyper Text Markup Language (HTML), Extensible HTML (XHTML), Extensible Markup Language (XML), etc. CSS describes how elements should be rendered on a display screen, on paper, in speech, or on other media. Most often CSS is used to set the visual style of web pages and user interfaces written in various markup languages. It is a technology used by most websites to create visually engaging webpages, user interfaces for web applications, and user interfaces for many mobile applications. CSS has a layout mode called a flexible box layout (or flexbox) designed for laying out complex applications and web pages. The flexible box layout of CSS has more flexibility for distributing space and aligning content in way that web applications and complex web pages often need. Content or layout of a social-networking website may be arranged using the flexible box layout.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user. One user may also send images and videos to other users of the social-networking system, such as those who are directly or indirectly connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touch screens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments disclose a method for dynamically arranging a layout of a page comprising three-dimensional (3D) objects using a two-dimensional (2D) flexible box model (interchangeably referred to herein as a flexbox). A flexbox in particular embodiments may be a dynamic CSS layout model that provides for the arrangement of various objects or elements on a page (e.g., webpage) such that the objects behave predictably when the page layout must accommodate different screen sizes and different display devices. For example, when a page switches its orientation from a landscape to a portrait mode, then flexbox enables the boxes, spacings between the boxes, text, tabs, etc. in the page to automatically adjust according to the portrait mode (e.g., spacing between boxes reduced, boxes arranged column-wise instead of row-wise, objects stacked to each other, objects stretched to fit certain area, etc.). Particular embodiments enable 3D objects to be dynamically arranged using the flexible box model. This may especially be valuable within the virtual reality and augmented reality contexts where there may be various 3D objects.

In particular embodiments, the way the 3D objects leverage 2D flexbox is by representing 3D objects in 2D, such as by taking a cross-section or projection of the 3D objects into 2D space to generate corresponding 2D objects. Various projection techniques may be used to project 3D points to a 2D plane. Some of the standard projection techniques may include, for example, orthographic projection, perspective projection, etc. Once the corresponding 2D points or objects of the 3D objects are generated, they may be placed into the flexbox (e.g., the 2D representations of the 3D objects are put into flex containers). Using the flexbox, the layout of the various objects (2D representations of 3D objects) regarding how they should be presented (or where they need to be rendered) on a page can be defined. For example, length, width, size, X-Y coordinates, orientation, relative spacing, etc. can be defined for the generated 2D objects using the flexbox. The layout definitions can then be transferred to a rendering engine for it render the various objects (2D and 3D) on a page. The rendering engine may apply some transformation techniques on the 2D representations of the 3D objects to render them in their original state (e.g., replace the 2D object(s) with corresponding 3D representation(s) at the location defined by the flexbox). In some embodiments, every time there is a change in layout/orientation on a page, the rendering engine may call the flexbox, which provides the new position, size, coordinates, etc. information to the rendering engine for it to render an updated scene.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1D illustrate various examples of dynamically arranging a layout of a page comprising 3D objects using a flexible box model.

FIG. 2 is a flowchart of an example method for rendering a display containing one or more 3D objects using run-time layout characteristics defined by a flexible box model.

FIG. 3 illustrates an example network environment associated with a social-networking system.

FIG. 4 illustrates an example computer system.

### DESCRIPTION OF EXAMPLE EMBODIMENTS

Particular embodiments describe a method for dynamically arranging a layout of a page comprising three-dimensional (3D) objects using a two-dimensional (2D) flexible box model (interchangeably referred to herein as a flexbox). A flexbox may include flex containers and one or more flex items in each of the flex containers. Use of the flexbox ensures that the contents or flex items of a flex container behave predictably when a page layout (e.g., a webpage layout) must accommodate different screen sizes and different display devices. For example, a flexbox may allow the contents or one or more flex items to (1) be laid out in any flow direction (leftwards, rightwards, downwards, upwards), which allows for the creation of more adaptive and responsive layouts that adapt to the layout changes on different screen sizes and orientations, (2) be stretched and shrunk to accommodate the available space, and be sized in proportional to each other and any available space between or around them, (3) have their display order reversed or rearranged at the style layer, (4) be dynamically collapsed or uncollapsed along the main axis while preserving the container's cross size, (5) be laid out linearly along a single (main) axis or wrapped into multiple lines along a second (cross) axis, and (6) be aligned with respect to their container or each other on the secondary (cross) axis. The contents or flex items of a flex container may be associated with a social-networking website, which may be hosted on a social-networking system 360.

Particular embodiments enable 3D objects to be dynamically arranged using the flexible box model. This may especially be valuable within the virtual reality and augmented reality contexts where there may be various 3D objects. In particular embodiments, the way 3D objects leverage 2D flexbox is by representing 3D objects in 2D, such as by taking a cross-section or projection of the 3D objects into 2D space to generate corresponding 2D objects. Various projection techniques may be used to project 3D points to a 2D plane. Some of the standard projection techniques may include, for example, orthographic projection, perspective projection, etc. Once the corresponding 2D points or objects of the 3D objects are generated, they may be placed into the flexbox (e.g., the 2D representations of the 3D objects are put into flex containers). Using the flexbox, the layout of the various objects (2D representations of 3D objects) regarding how they should be presented (or where they need to be rendered) on a page can be defined. For example, length, width, size, X-Y coordinates, orientation, relative spacing, etc. can be defined for the generated 2D objects using the flexbox. The layout definitions can then be transferred to a rendering engine (e.g., rendering engine 114) for it render the various objects (2D and 3D) on a page. The rendering engine may apply some transformation techniques on the 2D representations of the 3D objects to render them in their original state (e.g., replace the 2D object(s) with corresponding 3D representation(s) at the location defined by the flexbox). In some embodiments, every time there is a change in layout/orientation on a page, the rendering engine may call the flexbox, which provides the new position, size, coordinates, etc. information to the rendering engine for it to render an updated scene.

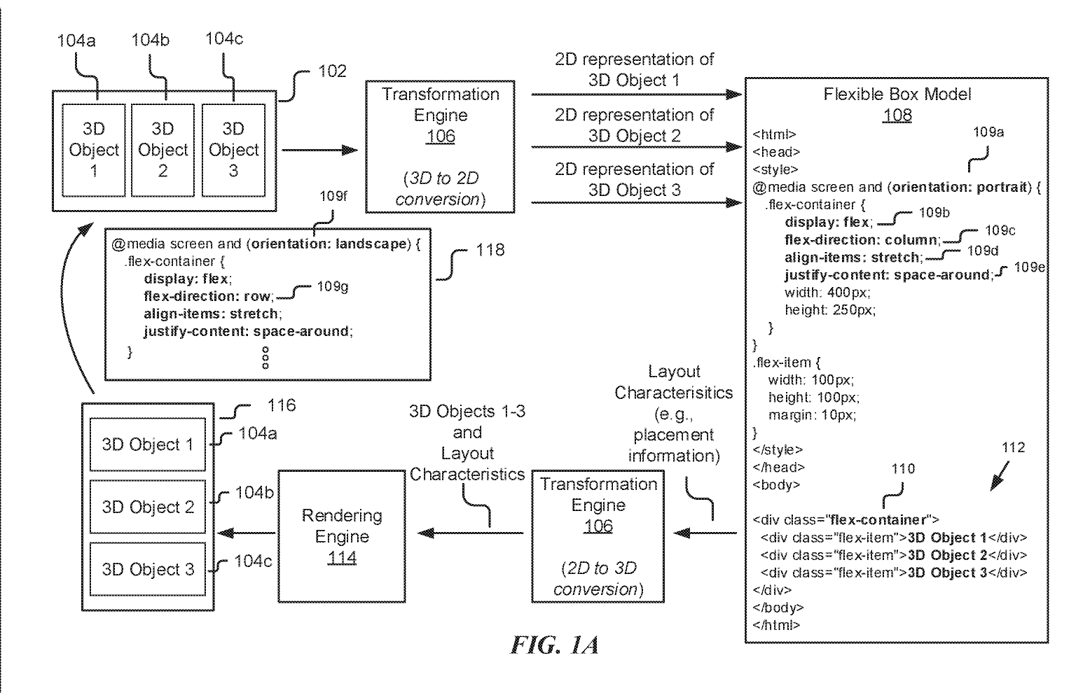

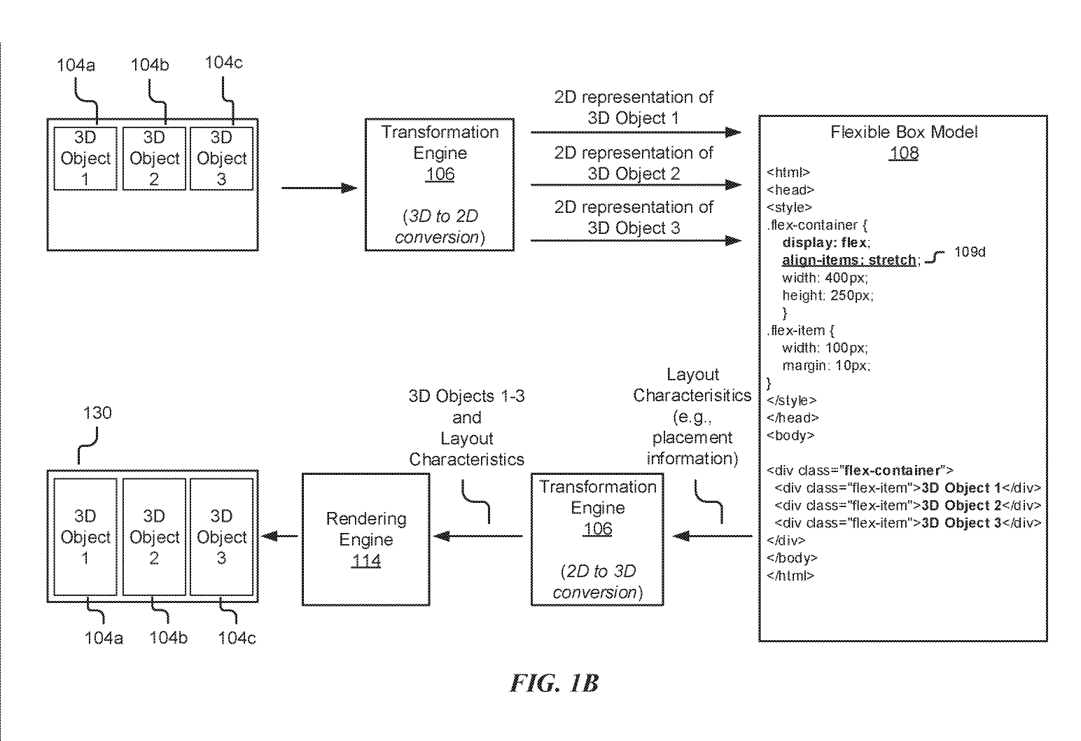

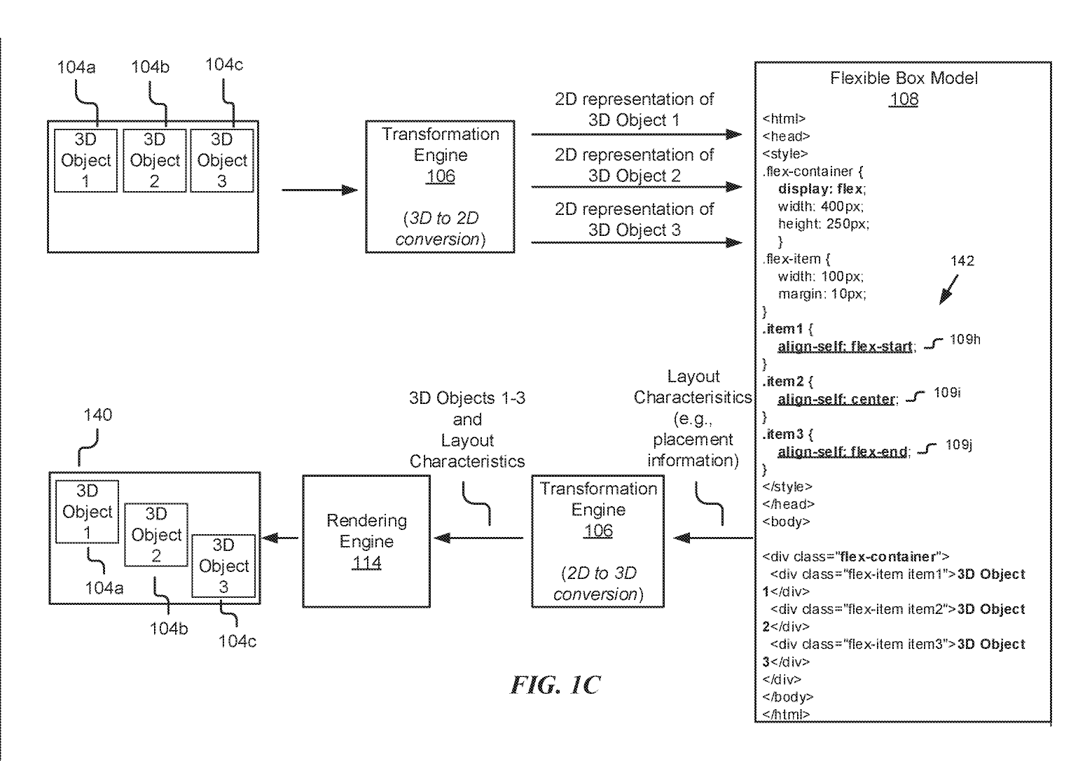

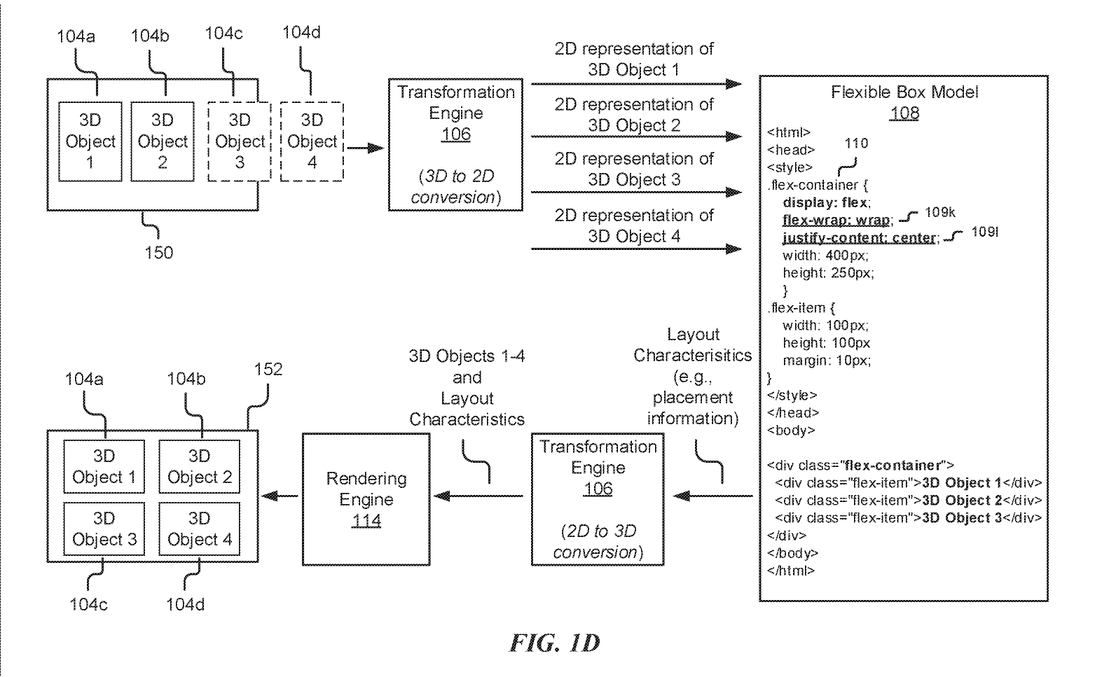

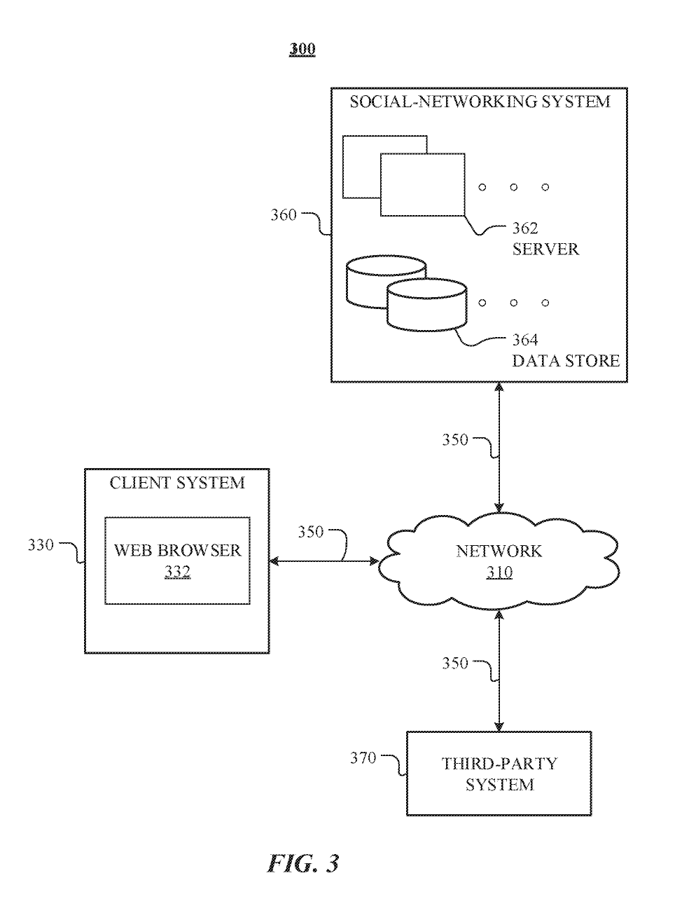

Particular embodiments are now discussed with respect to some example layouts in reference to FIGS. 1A-1D. These figures illustrate various examples of dynamically arranging a layout of a page (e.g., a webpage) comprising 3D objects using a flexible box model (or flexbox). FIG. 1A illustrates an example of a first page layout 116 comprising 3D objects that may be defined using the flexible box model 108. Specifically, FIG. 1A illustrates dynamically arranging 3D objects at run-time for display from a landscape page layout 102 to a portrait layout 116. As depicted, a page 102 may include 3D objects 104a-104c (individually and/or collectively referred to herein as 104). As an example and not by way of limitation, the page 102 may be a media feed (associated with an social network) including a plurality of 3D objects, such as the 3D objects 104. The page 102 may be displayed on a web browser 332 or a native application running on a client system 330, discussed in detail below in reference to FIG. 3. In the depicted embodiment, the page 102 is laid out in a landscape format where the 3D objects 104 are arranged horizontally in a row-wise manner. If the same page is rendered at run-time in a portrait format (e.g., page 102 flips 90 degrees to page layout 116) or in devices where the display screen is narrower than the display where the page 102 is originally rendered then the 3D objects 104 may need to arrange according to the new display size, format, and/or dimensions at run-time. The run-time layout characteristics of the 3D objects 104 may be defined using the flexible box model 108. The 3D objects 104 may be placed as flex items in a flex container 110 of the flexible box model 108 so that one or more layout properties or configurations may be defined for these objects. In order to place these objects into a flex container, the 3D objects 104 may be first converted into their corresponding 2D representations.

In particular embodiments, a transformation engine 106 running on the client system 330 may generate corresponding 2D representations of the 3D objects 104. For instance, the transformation engine 106 may be a software code, logic, and/or routines for converting or projecting 3D objects into their corresponding 2D representations and vice versa. The transformation engine 106 may perform the conversion by taking a cross-section or projection of the 3D objects 104 into 2D space to generate corresponding 2D objects. The transformation engine 106 may apply a standard projection technique to project the 3D objects into 2D space or plane. For example, the transformation engine may perform this projection using an orthographic projection technique, a perspective projection technique, etc. Upon generating the corresponding 2D objects or representations of the 3D objects 104, the transformation engine 106 may send these 2D objects to the flexible box model 108.

The flexible box 108, as discussed elsewhere herein, may be used to define run-time layout characteristics of one or more objects. In particular, the flexible box model 108 may define placement or behavior information for the one or more objects on a page (e.g., a webpage) at run-time. The flexible box model 108 may define how the one or more objects be laid out on the page or act at run-time. The placement information defined by the flexible box model 108 for the one or more objects may include, for example, location or coordinates on the page where the one or more objects should be placed, size (e.g., height, width) of the objects on the page, margins, space around or between the objects, alignment (e.g., left, right, center, etc.), order in which each object should appear, the flow direction i.e., whether the objects be displayed vertically (column-wise) or horizontally (row-wise) on the page, etc.

Using the flexible box model 108, one or more layout properties (e.g., properties 109a, 109b, 109c, etc.) may be defined for the one or more objects. In order to define the layout properties on an object, the object may need to be placed as a flex item inside a flex container. Once the object is placed as a flex item, one or more layout properties may be defined for the object inside the flex container. In the examples discussed herein in reference to FIGS. 1A-1D, the flexible box model 108 may receive the 2D representations (or 2D objects) corresponding to the 3D objects 104 from the transformation engine 106 and then place these objects as flex items inside a flex container 110 (as indicated by reference numeral 112). Inside the flex container 110, layout properties 109a-109e may be defined for presenting the page layout 116 at run-time. In particular, layout property 109a “@mediascreen and (orientation: portrait)” enables one or more flex items contained in the flex container 110 to be laid out in a column when a client system 330 (e.g., a mobile device) is in portrait orientation; layout property 109b “display: flex” creates or instantiates the flex container 110 in which the one or more flex items may be laid out, layout property 109c “flex-direction: column” allows the one or more flex items to be laid out vertically in a column-wise format at run-time, layout property 109d “align-items: stretch” stretches the one or more flex items to fill up the available space of a page; and layout property 109e “justify-content: space-around” positions the flex items in a way such that there is equal space before, between, and after the items. The layout properties may either be defined overall for the one or more flex items (i.e., the flex items behave equally at run-time) or may be defined individually for each flex item, as shown and discussed in reference to FIG. 1C.

Once the layout characteristics comprising the layout properties of the 3D objects 104 (or 2D representations of the 3D objects 104) are defined, the layout characteristics may be sent back to the transformation engine 106, which then converts the 2D representations of the 3D objects 104 back to their original state (i.e., 3D). The 3D objects 104 along with the layout characteristics may be send to a rendering engine 114, which then uses the layout characteristics or placement defined by the flexible box model 108 to render the page layout 116. As mentioned earlier, the page layout 116 may be laid out when a client system 330 is in a portrait orientation. As an example and not by way of limitation, the page layout 116 may be laid out by default on a smartphone's display or on a computer monitor that is rotated/flipped 90 degrees from its original landscape orientation.

Using the process discussed above, the page layout 116 may be similarly switched from portrait to landscape at run-time based on layout characteristics 118 definable using the flexible box model 108. For example, layout properties 109a and 109c may be replaced with layout properties 109f and 109g, respectively that enables the 3D objects 104 to be laid out horizontally in a row-wise format when a client system 330 is in the landscape orientation. In particular embodiments, to display a particular page at run-time, a client application (e.g., a web browser 332) running on a client system 330 may call the flexible box model 108 to receive appropriate layout characteristics and use the layout characteristics to display the page via the rendering engine 114.

FIG. 1B illustrates an example of a second page layout 130 that may be defined using the flexible box model 108 discussed herein. In this example, layout characteristics defined for the 3D objects 104 enable them to stretch their size at run-time to occupy the entire viewing or displayable area of a page. For example, contents displayed in a smaller screen (e.g., a mobile device) may occupy less space as compared to when they are displayed on a larger screen (e.g., a TV or a computer monitor). The layout characteristics defined by the flexible box model 108 in this example enable the 3D objects 104 to automatically stretch at run-time to occupy all the available space, as shown in the page layout 130. For this, the layout property 109d “align-items: stretch” may be defined inside the flex container 110. By default, activating this property gives an equal stretch size to all the objects contained inside the flex container 110. That is, each of the objects 104 may stretch by an equal amount to fill the displaying region of the page. However, this is not limiting and different size proportions may be assigned to the objects using a layout property “flex-grow: <number>” (not shown). For example, by defining the property “flex-grow: 2” for 3D object 104a enables it to grow twice the size as that of the 3D objects 104b and 104c.

FIG. 1C illustrates an example of a third page layout 140 that may be defined using the flexible box model 108 discussed herein. In this example, a layout property may individually be defined for each 3D object 104 (indicated by reference numeral 142) for displaying the objects 104 at different locations at run-time on the page, as shown in the page layout 140. For instance, a layout property 109h “align-self: flex-start” may be defined for object 104a to place it at the top left of the page, a layout property 109i “align-self: center” may be defined for object 104b to place it at the center of the page, and a layout property 109j “align-self: flex-end” may be defined for object 104c to place it at the bottom end of the page.

FIG. 1D illustrates an example of a fourth page layout 152 that may be defined using the flexible box model 108 discussed herein. In this example, layout properties defined by the flexible box model 108 may wrap one or more 3D objects to be placed within a displayable portion of the page. For instance, a layout property 109k “flex-wrap: wrap” may enable the one or more 3D objects to wrap onto additional flex lines or rows if there is not enough room for all the 3D objects 104 to be located on one single line. For example, as depicted in page layout 150, 3D object 104c is partially outside and object 104d is fully outside the displayable region or window of the page. By defining the layout property 109k in the flex container 110, the four 3D objects 104a-104d may be automatically adjusted to fit within the displayable region of the page, as shown in the page layout 152. Additionally, a layout property 109l “justify-content: center” may be defined along with the property 109k so that the objects 104 may be equally positioned at the center of the page.

Although the above examples in FIGS. 1A-1D discuss configuring run-time layout of three or four 3D objects using the flexible box model 108, it should be understood that this is not limiting and configuring a page layout comprising any number of 3D objects or a combination of 2D and 3D objects is possible and within the scope of the present disclosure.

The following non-limiting example is provided to further discuss the various aspects covered in FIGS. 1A-1D with respect to a game interface. The game interface may be displayed as a webpage on a web browser 332 of a client system 330. The game interface may include a game menu that may have some 2D boxes containing game name, player scores, leadership board, etc. and may have a play button in 3D located below the 2D boxes. The game interface may also include a 3D lever (appear to be sticking out of screen) that can be interacted by a user to play the game. The 3D play button and lever may be transformed into 2D (e.g., by the transformation engine 106) and then their layout definitions along with layout definitions for other 2D objects can be defined using the flexbox box model 108. The flexible box model 108 may define how these 2D objects (some of which may correspond to 3D objects) will look and behave at run time. For example, flexbox may define that these objects may stretch to fit the whole area or width of the page at any given orientation (landscape or portrait). For this, size, position, and coordinates of the various 2D elements are defined (which in turn define the corresponding 3D objects) in the CSS sheet using flexbox. The flex layout definitions (i.e., size, positions, coordinates, etc.) of the 2D objects that correspond to 3D objects are send to a 3D rendering engine (e.g., the rendering engine 114), which then displays the game interface at run time to the user.

In particular embodiments, once an interface or a page layout has been rendered by the rendering engine 114, input events (e.g., touch events) received on one or more 3D objects (e.g., 3D objects 104) may be handled using a combination of a standard touch handler (associated with an operating system running on a client system 330) and a custom three-dimensional (3D) touch handler (associated with an application running on the client system 330). The two touch handlers may work together to handle received touch events intended for different targets/objects in the interface. For instance, the custom 3D touch handler may process touch events relating to 3D objects 104 in an asynchronous manner, and the standard OS touch handler may process touch events that are intended for system-level-user-interface objects or objects that are part of or integrated into the visual scene in a synchronous manner. In some embodiments, 3D objects 104 may be objects overlaid on top of a real-world scene indicating information about the scene such as in an augmented reality (AR) environment. For example, a user may be capturing a photo/video using his mobile device and one or more objects may be overlaid on top of the photo/video to provide decorative/entertaining effects or indicate information regarding a scene being captured by the device's camera. In this example, when the user touches on one or more overlaid objects, the touches may be handled by the custom 3D touch handler while the touches on any other portions (e.g., tap to focus the camera) may be handled by the standard touch handler. Detailed description regarding how the two touch handlers work to handle/process touch events relating to 3D objects is disclosed in U.S. patent application Ser. No. 15/648,031, filed 12 Jul. 2017, the contents of which are hereby incorporated by reference.

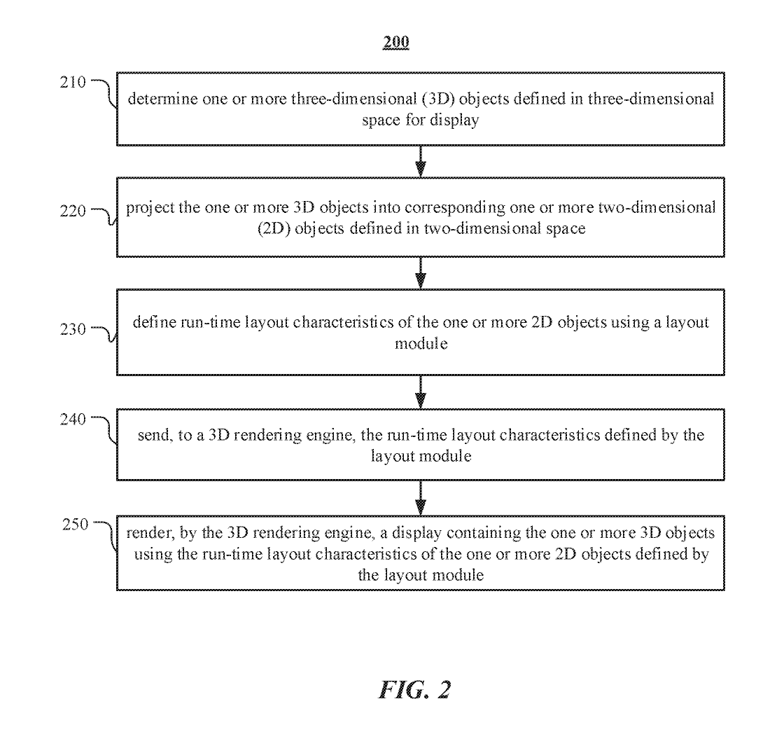

FIG. 2 is a flowchart of an example method 200 for rendering a display containing one or more three-dimensional (3D) objects using run-time layout characteristics defined by a flexible box model. The method may begin at step 210, where one or more three-dimensional (3D) objects may be defined in 3D space for display on a client system 330. At step 220, the one or more 3D objects may be projected into corresponding one or more two-dimensional (2D) objects defined in 2D space. For example, the transformation engine 106 may project the one or more 3D objects into their corresponding 2D representations. In particular embodiments, projecting the one or more 3D objects into corresponding one or more 2D objects includes computing a 2D cross-section of each of the 3D objects. A 2D cross-section of a 3D object may be computed by using standard projection techniques such as orthographic projection, perspective projection, etc. At step 230, run-time layout characteristics of the one or more 2D objects may be defined using a layout module. For instance, the run-time layout characteristics may be defined using a flexible box model 108 (as discussed in reference to at least FIGS. 1A-1D). The run-time layout characteristics may indicate placement information for the one or more 2D objects on a display region. The placement information may include one or more of a length, a width, a size, position or location coordinates, an orientation, or a relative spacing between the one or more 2D objects on the display region. At step 240, the run-time layout characteristics defined by the layout module may be send to a 3D rendering engine (e.g., the rendering engine 114). At step 250, the 3D rendering engine may render a display containing the one or more 3D objects using the run-time layout characteristics of the one or more 2D objects defined by the layout module. In some embodiments, the rendering engine may apply some transformation techniques on the 2D representations of the 3D objects to render them in their original state (i.e., replace the 2D object(s) with corresponding 3D representation(s)) and then render the objects at the location defined by the layout module. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for rendering a display containing one or more 3D objects using run-time layout characteristics defined by a flexible box model including the particular steps of the method of FIG. 2, this disclosure contemplates any suitable method for rendering a display containing one or more 3D objects using run-time layout characteristics defined by a flexible box model, including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

FIG. 3 illustrates an example network environment 300 associated with a social-networking system. Network environment 300 includes a client system 330, a social-networking system 360, and a third-party system 370 connected to each other by a network 310. Although FIG. 3 illustrates a particular arrangement of a client system 330, a social-networking system 360, a third-party system 370, and a network 310, this disclosure contemplates any suitable arrangement of a client system 330, a social-networking system 360, a third-party system 370, and a network 310. As an example and not by way of limitation, two or more of a client system 330, a social-networking system 360, and a third-party system 370 may be connected to each other directly, bypassing a network 310. As another example, two or more of a client system 330, a social-networking system 360, and a third-party system 370 may be physically or logically co-located with each other in whole or in part. Moreover, although FIG. 3 illustrates a particular number of client systems 330, social-networking systems 360, third-party systems 370, and networks 310, this disclosure contemplates any suitable number of client systems 330, social-networking systems 360, third-party systems 370, and networks 310. As an example and not by way of limitation, network environment 300 may include multiple client systems 330, social-networking systems 360, third-party systems 370, and networks 310.

This disclosure contemplates any suitable network 310. As an example and not by way of limitation, one or more portions of a network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 310 may include one or more networks 310.

Links 350 may connect a client system 330, a social-networking system 360, and a third-party system 370 to a communication network 310 or to each other. This disclosure contemplates any suitable links 350. In particular embodiments, one or more links 350 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 350, or a combination of two or more such links 350. Links 350 need not necessarily be the same throughout a network environment 300. One or more first links 350 may differ in one or more respects from one or more second links 350.

In particular embodiments, a client system 330 may be an electronic device including hardware, software, or embedded logic components or a combination of two or more such components and capable of carrying out the appropriate functionalities implemented or supported by a client system 330. As an example and not by way of limitation, a client system 330 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 330. A client system 330 may enable a network user at a client system 330 to access a network 310. A client system 330 may enable its user to communicate with other users at other client systems 330.

In particular embodiments, a client system 330 may include a web browser 332, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 330 may enter a Uniform Resource Locator (URL) or other address directing a web browser 332 to a particular server (such as server 362, or a server associated with a third-party system 370), and the web browser 332 may generate a Hyper Text Transfer Protocol (HTTP) request and communicate the HTTP request to server. The server may accept the HTTP request and communicate to a client system 330 one or more Hyper Text Markup Language (HTML) files responsive to the HTTP request. The client system 330 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 360 may be a network-addressable computing system that can host an online social network. The social-networking system 360 may generate, store, receive, and send social-networking data, such as, for example, user-profile data, concept-profile data, social-graph information, or other suitable data related to the online social network. The social-networking system 360 may be accessed by the other components of network environment 300 either directly or via a network 310. As an example and not by way of limitation, a client system 330 may access the social-networking system 360 using a web browser 332, or a native application associated with the social-networking system 360 (e.g., a mobile social-networking application, a messaging application, another suitable application, or any combination thereof) either directly or via a network 310. In particular embodiments, the social-networking system 360 may include one or more servers 362. Each server 362 may be a unitary server or a distributed server spanning multiple computers or multiple datacenters. Servers 362 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 362 may include hardware, software, or embedded logic components or a combination of two or more such components for carrying out the appropriate functionalities implemented or supported by server 362. In particular embodiments, the social-networking system 360 may include one or more data stores 364. Data stores 364 may be used to store various types of information. In particular embodiments, the information stored in data stores 364 may be organized according to specific data structures. In particular embodiments, each data store 364 may be a relational, columnar, correlation, or other suitable database. Although this disclosure describes or illustrates particular types of databases, this disclosure contemplates any suitable types of databases. Particular embodiments may provide interfaces that enable a client system 330, a social-networking system 360, or a third-party system 370 to manage, retrieve, modify, add, or delete, the information stored in data store 364.

In particular embodiments, the social-networking system 360 may store one or more social graphs in one or more data stores 364. In particular embodiments, a social graph may include multiple nodes—which may include multiple user nodes (each corresponding to a particular user) or multiple concept nodes (each corresponding to a particular concept)—and multiple edges connecting the nodes. The social-networking system 360 may provide users of the online social network the ability to communicate and interact with other users. In particular embodiments, users may join the online social network via the social-networking system 360 and then add connections (e.g., relationships) to a number of other users of the social-networking system 360 whom they want to be connected to. Herein, the term “friend” may refer to any other user of the social-networking system 360 with whom a user has formed a connection, association, or relationship via the social-networking system 360.

In particular embodiments, the social-networking system 360 may provide users with the ability to take actions on various types of items or objects, supported by the social-networking system 360. As an example and not by way of limitation, the items and objects may include groups or social networks to which users of the social-networking system 360 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 360 or by an external system of a third-party system 370, which is separate from the social-networking system 360 and coupled to the social-networking system 360 via a network 310.

In particular embodiments, the social-networking system 360 may be capable of linking a variety of entities. As an example and not by way of limitation, the social-networking system 360 may enable users to interact with each other as well as receive content from third-party systems 370 or other entities, or to allow users to interact with these entities through an application programming interfaces (API) or other communication channels.

In particular embodiments, a third-party system 370 may include one or more types of servers, one or more data stores, one or more interfaces, including but not limited to APIs, one or more web services, one or more content sources, one or more networks, or any other suitable components, e.g., that servers may communicate with. A third-party system 370 may be operated by a different entity from an entity operating the social-networking system 360. In particular embodiments, however, the social-networking system 360 and third-party systems 370 may operate in conjunction with each other to provide social-networking services to users of the social-networking system 360 or third-party systems 370. In this sense, the social-networking system 360 may provide a platform, or backbone, which other systems, such as third-party systems 370, may use to provide social-networking services and functionality to users across the Internet.

In particular embodiments, a third-party system 370 may include a third-party content object provider. A third-party content object provider may include one or more sources of content objects, which may be communicated to a client system 330. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 360 also includes user-generated content objects, which may enhance a user's interactions with the social-networking system 360. User-generated content may include anything a user can add, upload, send, or “post” to the social-networking system 360. As an example and not by way of limitation, a user communicates posts to the social-networking system 360 from a client system 330. Posts may include data such as status updates or other textual data, location information, photos, videos, links, music or other similar data or media. Content may also be added to the social-networking system 360 by a third-party through a “communication channel,” such as a newsfeed or stream.

In particular embodiments, the social-networking system 360 may include a variety of servers, sub-systems, programs, modules, logs, and data stores. In particular embodiments, the social-networking system 360 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 360 may also include suitable components such as network interfaces, security mechanisms, load balancers, failover servers, management-and-network-operations consoles, other suitable components, or any suitable combination thereof. In particular embodiments, the social-networking system 360 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 360 to one or more client systems 330 or one or more third-party systems 370 via a network 310. The web server may include a mail server or other messaging functionality for receiving and routing messages between the social-networking system 360 and one or more client systems 330. An API-request server may allow a third-party system 370 to access information from the social-networking system 360 by calling one or more APIs. An action logger may be used to receive communications from a web server about a user's actions on or off the social-networking system 360. In conjunction with the action log, a third-party-content-object log may be maintained of user exposures to third-party-content objects. A notification controller may provide information regarding content objects to a client system 330. Information may be pushed to a client system 330 as notifications, or information may be pulled from a client system 330 responsive to a request received from a client system 330. Authorization servers may be used to enforce one or more privacy settings of the users of the social-networking system 360. A privacy setting of a user determines how particular information associated with a user can be shared. The authorization server may allow users to opt in to or opt out of having their actions logged by the social-networking system 360 or shared with other systems (e.g., a third-party system 370), such as, for example, by setting appropriate privacy settings. Third-party-content-object stores may be used to store content objects received from third parties, such as a third-party system 370. Location stores may be used for storing location information received from client systems 330 associated with users. Advertisement-pricing modules may combine social information, the current time, location information, or other suitable information to provide relevant advertisements, in the form of notifications, to a user.

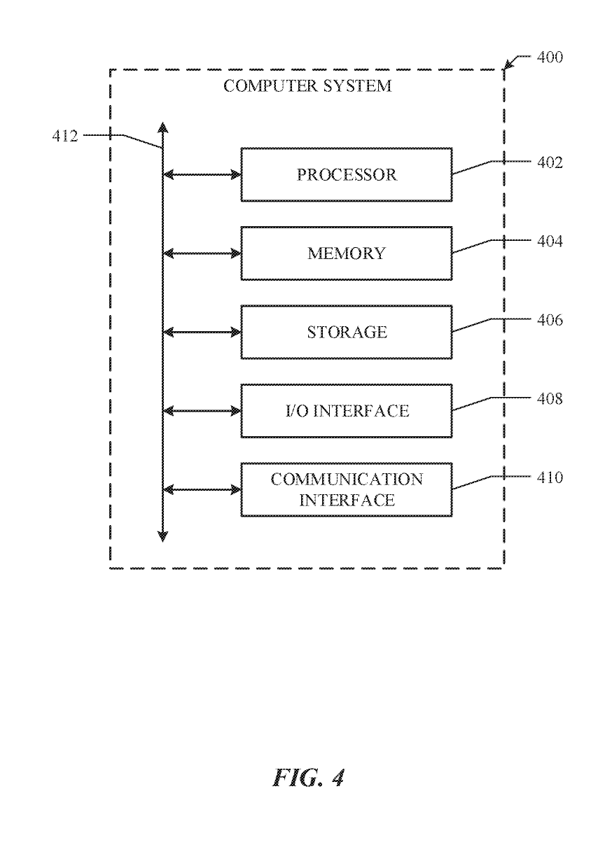

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computer systems:
determining one or more three-dimensional (3D) objects defined in three-dimensional space for display;
projecting the one or more 3D objects into corresponding one or more two-dimensional (2D) objects defined in two-dimensional space;
defining run-time layout characteristics of the one or more 2D objects using a layout module;
sending, to a 3D rendering engine, the run-time layout characteristics defined by the layout module; and
rendering, by the 3D rendering engine, a display containing the one or more 3D objects using the run-time layout characteristics of the one or more 2D objects defined by the layout module.

2. The method of claim 1, wherein projecting the one or more 3D objects into the corresponding one or more 2D objects comprises computing a 2D cross-section of each of the 3D objects.

3. The method of claim 1, wherein the run-time layout characteristics defined by the layout module indicate placement information for the one or more 2D objects on a display region.

4. The method of claim 3, wherein the placement information comprises one or more of a length, a width, a size, position or location coordinates, an orientation, or a relative spacing between the one or more 2D objects on the display region.

5. The method of claim 4, wherein rendering the display containing the one or more 3D objects comprises:
transforming the projected one or more 2D objects back to the corresponding one or more 3D objects; and
placing the one or more 3D objects in the display region using the placement information indicated by the layout module.

6. The method of claim 1, further comprising:
after rendering the display, receiving one or more touch events on the one or more 3D objects; and
processing the one or more touch events using one or more of a first touch event handler or a second touch event handler.

7. The method of claim 6, wherein:
the first touch event handler is an operating system (OS) handler that is configured to process touch events synchronously; and
the second touch event handler is a custom 3D handler that is configured to process touch events asynchronously.

8. The method of claim 6, wherein the one or more 3D objects are associated with a virtual reality or augmented reality display.

9. The method of claim 1, wherein the layout module is a dynamic layout module that provides for dynamic arrangement of 2D objects in a display region at runtime.

10. The method of claim 1, wherein the projecting of the one or more 3D objects uses one or more of an orthographic or a perspective projection.

11. One or more computer-readable non-transitory storage media embodying software that is operable when executed to:
determine one or more three-dimensional (3D) objects defined in 3D space for display;
project the one or more 3D objects into corresponding one or more two-dimensional (2D) objects defined in 2D space;
define run-time layout characteristics of the one or more 2D objects using a layout module;
send, to a 3D rendering engine, the run-time layout characteristics defined by the layout module; and
render, by the 3D rendering engine, a display containing the one or more 3D objects using the run-time layout characteristics of the one or more 2D objects defined by the layout module.

12. The media of claim 11, wherein the run-time layout characteristics defined by the layout module indicate placement information for the one or more 2D objects on a display region.

13. The media of claim 12, wherein the placement information comprises one or more of a length, a width, a size, position or location coordinates, an orientation, or a relative spacing between the one or more 2D objects on the display region.

14. The media of claim 13, wherein to render the display containing the one or more 3D objects, the software is further operable to:
transform the projected one or more 2D objects back to the corresponding one or more 3D objects; and
place the one or more 3D objects in the display region using the placement information indicated by the layout module.

15. The media of claim 11, wherein to project the one or more 3D objects into the corresponding one or more 2D objects, the software is further operable to compute a 2D cross-section of each of the 3D objects.

16. A system comprising: one or more processors; and a non-transitory memory coupled to the processors comprising instructions executable by the processors, the processors operable when executing the instructions to:
determine one or more three-dimensional (3D) objects defined in 3D space for display;
project the one or more 3D objects into corresponding one or more two-dimensional (2D) objects defined in 2D space;
define run-time layout characteristics of the one or more 2D objects using a layout module;
send, to a 3D rendering engine, the run-time layout characteristics defined by the layout module; and
render, by the 3D rendering engine, a display containing the one or more 3D objects using the run-time layout characteristics of the one or more 2D objects defined by the layout module.

17. The system of claim 16, wherein the run-time layout characteristics defined by the layout module indicate placement information for the one or more 2D objects on a display region.

18. The system of claim 17, wherein the placement information comprises one or more of a length, a width, a size, position or location coordinates, an orientation, or a relative spacing between the one or more 2D objects on the display region.

19. The system of claim 18, wherein to render the display containing the one or more 3D objects using the run-time layout characteristics defined by the layout module, the processors are further operable to:
transform the projected one or more 2D objects back to the corresponding one or more 3D objects; and
place the one or more 3D objects in the display region using the placement information indicated by the layout module.

20. The system of claim 16, wherein to project the one or more 3D objects into the corresponding one or more 2D objects, the processors are further operable to compute a 2D cross-section of each of the 3D objects.
